(19) United States
(12) Patent Application Publication
(10) Pub. No.: US 2008/0154759 A1
(43) Pub. Date: Jun. 26, 2008

(54) Method and apparatus for arranging and displaying healthcare plans in an electronic chart format

(75) Inventors: Joshua P. Babyak, Davie, FL (US); Paul M. Price, Pembroke Pines, FL (US); George H. Michaelides, Skokie, IL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(73) Assignee: Dentalplans.com, Inc.

(21) Appl. No.: 11/643,374

(22) Filed: Dec. 20, 2006

(51) Int. Cl. G06Q 40/00

(52) U.S. Cl. 705/35

(57) ABSTRACT

A server maintained by or for a healthcare plan provider arranges and displays healthcare plans in an electronic chart format to a member of an organization preferably on a screen of the member's computer (e.g., via a website hosted on the server and accessed by the member). An application running on the server receives a geographic identifier from the member and determines an availability score for each of the healthcare plans based on the identifier. The application then selects a set of the healthcare plans based on the availability scores and determines a savings score for each of the plans in the set. Each savings score relates to the costs of providing a predetermined group of medical (e.g., dental) procedures. The application then organizes or orders the set of healthcare plans based at least on the availability and savings scores, and displays the ordered set in an electronic chart format.

### BACKGROUND OF THE INVENTION

1. Field of the Invention

The present invention relates generally to the administration of healthcare plans and, more particularly, to a method and apparatus for arranging and displaying healthcare plans to a member of an organization in an electronic chart format to facilitate the selection of a healthcare plan by the member.

2. Description of the Prior Art

Many employers or other organizations (e.g., warehouse clubs, universities, fraternal organizations, bar associations, automobile clubs, etc.) either provide healthcare insurance coverage to their employees or members, or provide the opportunity for their members to purchase insurance at discounted rates. Because these groups have a large membership base, healthcare insurance providers often allow the groups to purchase coverage for their members at a rate that is substantially lower than the member would otherwise be able to obtain independently. However, the number of plans offered and the type of coverage provided is usually quite limited.

Typically, the organization only offers their members a selection of a few healthcare plans. A group administrator (e.g., benefits coordinator) normally chooses what plans to offer based on consideration of a number of factors (e.g., the price of the organization's contribution to the premiums, the ease of administrating the selected plans, the provider's reputation for responding to filed claims, perceived needs of a majority of the members, etc.) The available plans are often offered through the same insurance carrier with the only choices being the type of coverage (e.g., Preferred Provider Organization (PPO), Health Maintenance Organization (HMO), and fee for service).

Many times, the selection of plans offered do not meet the member's individual needs. For example, the choice of plans may not offer coverage for necessary services provided by a specific doctor, dentist, or specialist. Additionally, certain procedures that the member requires may not be covered. The member may also be left with a selection of plans that provide more coverage than he or she actually needs or uses, but at a cost that is unaffordable. In these circumstances, the member must forego needed procedures or pay for them out of pocket, switch doctors, purchase insurance from a different source at a higher rate, or simply pass on the offered insurance plans and bear the risk of not having coverage at all.

Additionally, the organization may have to pay a set rate to the healthcare insurance provider based on the number of members of the group or the number of members the group believes may opt to purchase the offered insurance plans. Often, the price of the premiums paid by the organization is determined based on a membership range. For example, a group under 25 members may pay one price while a group having 25-50 members pays another rate. A group whose membership is in the low end of the range pays more per member than it would if there were more members.

Therefore, a need exists for, among other things, a method for selecting a healthcare plan from a pool of available healthcare plans that is tailored to fit the needs of an individual member, and for providing convenient group healthcare plan administration that overcomes the shortcomings of the prior art.

### BRIEF DESCRIPTION OF THE DRAWINGS

FIG. 1 is a block diagram of a healthcare provider administration system in accordance with one embodiment of the present invention.

FIG. 2 is a block diagram illustrating a healthcare plan provider server of the system of FIG. 1 according to an exemplary embodiment of the present invention.

FIGS. 3-6 are logic flow diagrams illustrating steps executed by a healthcare plan provider server and/or a healthcare plan provider in implementing exemplary methods for administering healthcare benefits to members of an organization in accordance with exemplary embodiments of the present invention.

FIG. 7 is an exemplary interactive web-based enrollment form depicting enrollment options for a selecting a healthcare plan.

FIGS. 8-11 are exemplary screen views of interactive tools displayed to the group administrator for managing group enrollment and accessing billing information for the organization's healthcare benefits, in accordance with one embodiment of the present invention.

### DETAILED DESCRIPTION OF EXEMPLARY EMBODIMENT(S)

Before describing in detail exemplary embodiments that are in accordance with the present invention, it should be observed that the embodiments reside primarily in combinations of apparatus components and processing steps related to implementing a system and method for selection and administration of healthcare provider plans. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

Additionally, as used herein and in the appended claims, a “healthcare plan” means any insurance or benefit plan intended to assist a subscriber or member in paying for any charges incurred for seeking care from any health care service provider or in reducing the fees that would otherwise be incurred by the member absent membership in the plan. A healthcare plan includes, but is not limited to, medical plans, dental plans, vision plans, veterinary plans, prescription medication plans, or any combination thereof.

Generally, the present invention encompasses a system and method for administering healthcare benefits to members of an organization and for providing a convenient, practical manner of enabling an eligible member to select a healthcare plan from a variety of plans that best fits the individual's needs. In a preferred embodiment the variety of healthcare plans includes discount dental plans.

In accordance with one embodiment of the present invention, a healthcare plan provider (e.g., a healthcare insurance carrier, a healthcare insurance broker) issues a number of voucher codes to an organization for distribution to its members who are eligible to receive healthcare benefits. The voucher codes are included on a voucher (e.g., paper, electronic, or otherwise) to facilitate the member's enrollment in a healthcare plan chosen from a variety of plans offered by multiple healthcare insurance carriers. The healthcare plan provider bills the organization based upon the number of vouchers that have been redeemed by group members, not the number of vouchers issued or the number of potential group members. Additionally, each member who enrolls in a participating healthcare plan receives a membership card which may entitle the member to receive discounts when purchasing prescription medication.

In an alternative embodiment, eligible members are assisted with the selection of a suitable healthcare plan according to criteria collected from the member concerning his or her individual healthcare plan needs. A web-based virtual salesperson wizard requests that the member answer a series of questions relating to the healthcare plan needs of the member and the priority of such needs. Based on the responses to the questions, members are presented a number of available healthcare plan options for comparison, where the options are ordered in a manner most likely suited to fill the member's individual needs.

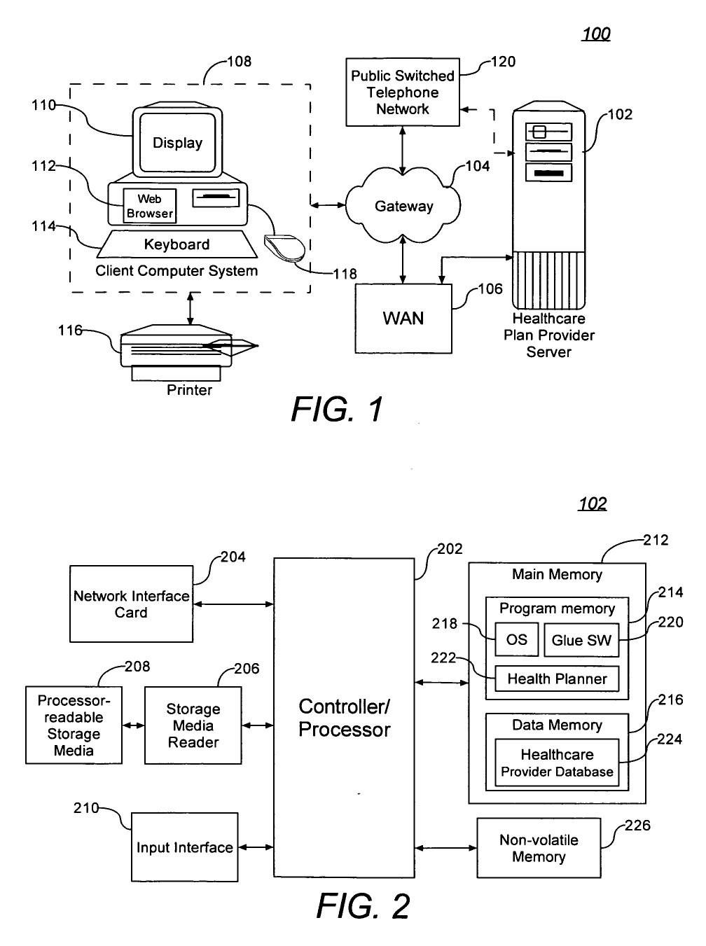

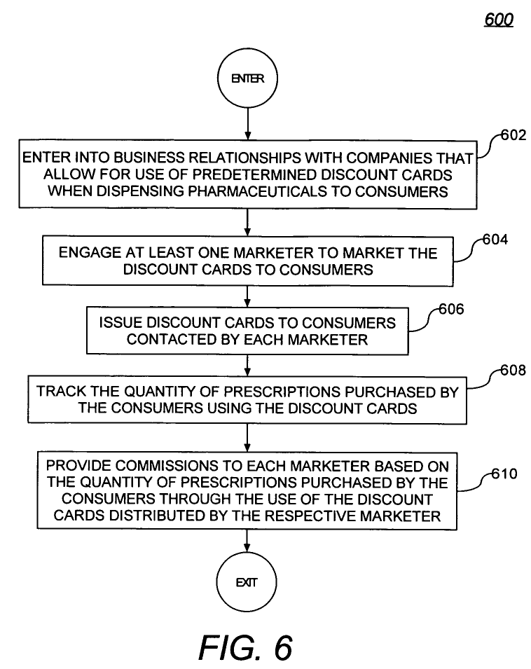

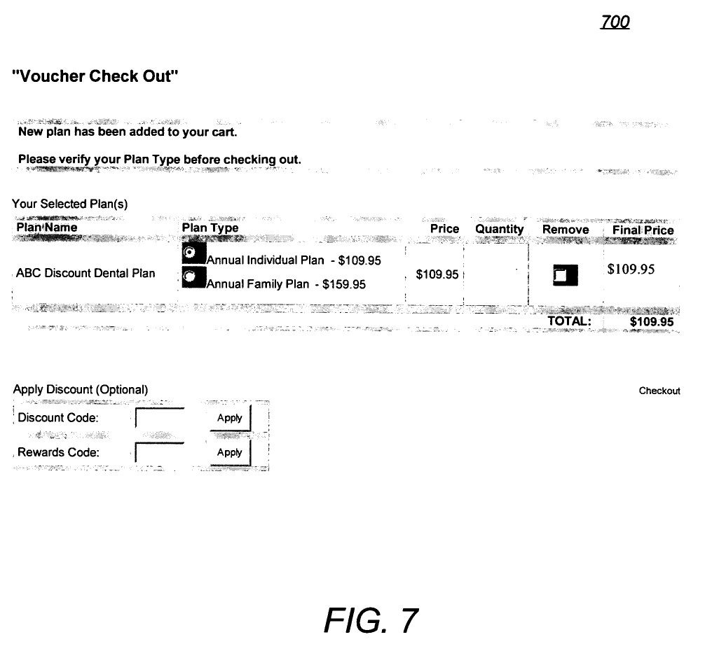

The present invention can be more readily understood with reference to FIGS. 1-6, in which like reference numerals designate like items. FIG. 1 depicts an exemplary healthcare provider administration system 100 in accordance with one embodiment of the present invention. The depicted system 100 includes a healthcare plan provider server 102 maintained by a healthcare plan provider (e.g., healthcare insurance carrier, healthcare insurance broker) and at least one client computer system 108. A member of an organization who is eligible to receive healthcare benefits may enroll in a healthcare insurance plan by selecting an available healthcare insurance plan from a pool of plans presented on a client computer system 108 by the healthcare plan provider server 102. The healthcare plan provider server 102 and the client computer system 108 are preferably connected to each other and an external wide area network 106, such as the Internet, a public switched telephone network (PSTN) 120, a digital subscriber line (DSL) network, a cable network, an integrated services digital network (ISDN), or any other appropriate wide area network, via a wireline and/or wireless gateway 104. The healthcare plan provider server 102 is preferably implemented to control the distribution of healthcare plan information to and from the client computer system 108.

The client computer system 108 preferably includes a web browser 112 for accessing information concerning individual healthcare plan needs from the healthcare plan provider server 102 and transmitting requests to the healthcare plan provider server 102 from the client computer 108 via the Internet. In one embodiment, the client computer system 108 includes a monitor or display 110 for presenting information to a user, and at least one input device, such as a keyboard 114 or mouse 118, for receiving input requests from the user. Additionally, the client computer system 108 may be communicatively coupled to a printer 116 for, inter alia, printing healthcare plan membership cards.

Referring now to FIG. 2, an electrical block diagram of an exemplary healthcare plan provider server 102, according to one embodiment of the present invention, is shown in more detail. Each healthcare plan provider server 102 includes a controller/processor 202, which processes instructions, performs calculations, and controls the flow of information through the healthcare plan provider server 102 according to computer instructions stored in program memory 214.

The controller/processor 202 is communicatively coupled to a non-volatile memory 226 and a main memory 212. In one embodiment, the main memory 212 includes the program memory 214 and a data memory 216. In one embodiment, the program memory 214 contains a healthcare planner 222, an operating system platform 218, and glue software 220. The operating system platform 218 manages resources such as the data stored in data memory 216, schedules tasks, and processes the operation of the healthcare planner 222, as discussed in greater detail below. The operating system platform 218 also manages an input interface 210 which receives inputs from a keyboard or mouse (not shown), and a network interface card 204 which communicates with other devices through a wired and/or wireless communication link. Additionally, the operating system platform 218 also manages many other basic tasks of the healthcare plan provider server 102 in a manner well known to those of ordinary skill in the art.

In one embodiment, glue software 220 includes drivers, stacks, and low level application programming interfaces (APIs). The glue software provides basic functional components for use by the operating system platform 218 and by compatible applications that run on the operating system platform 218 for managing communication resources and processes in the healthcare plan provider server 102.

In one embodiment, the data memory 216 contains a healthcare provider database 224. Additionally or alternatively, the healthcare provider database 224 may be contained on a removable processor readable storage media 208 (e.g., a memory stick, a USB flash drive, a compact disc (CD), a digital video disk (DVD), a floppy disk, or any other portable data storage device), which is read by a removable storage media reader 206 functioning under the command of the controller/processor 202. In an alternative embodiment, the healthcare provider database 224 may be located on a server accessed remotely through the wide area network 106, or in any other memory that is accessible by the healthcare plan provider server 102.

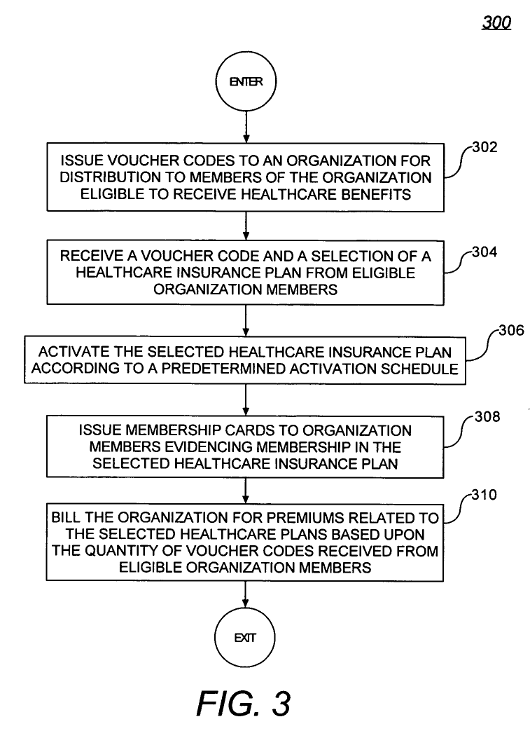

The healthcare provider administration system 100 implements a method, as depicted in FIG. 3, to provide health insurance benefits to groups, such as employers or other organizations, while allowing each group member to choose a personalized healthcare plan from a variety of plans provided by multiple vendors instead of limiting coverage options to a single provider. In a preferred embodiment of the present invention, the final choice for a healthcare coverage plan rests with the individual group member, not a group administrator.

Additionally, one embodiment of the present invention potentially provides significant cost savings for the group by requiring the organization to only pay for actual utilization and voucher redemption. In other words, the organization is only charged for those group members who actually participate by redeeming the vouchers, not according to the total number of vouchers requested or the number of potential members. In an alternative embodiment, a group administrator can easily add or remove group members using online resources, immediately updating billable items to reflect membership modifications.

Generally, as shown in FIG. 3, in response to receiving a request for group rates for available benefit products from an organization, a healthcare plan provider that maintains the healthcare plan provider server 102 generates a series of unique alphanumeric voucher codes and provides these voucher codes to the organization's benefits administrator for distribution to members of the group or organization that are eligible to receive healthcare benefits. The group administrator issues a unique voucher code to each eligible member of the group (302). By following instructions provided by the healthcare plan provider detailing how to search through available plans and redeem the voucher, each eligible group member selects a plan for enrollment on an individual basis. The healthcare plan provider receives a voucher code for enrollment and a corresponding healthcare insurance plan selection from eligible members of the group (304) (e.g., through an Internet website accessed by the member using a web-browser 112 or by a representative of the healthcare plan provider entering the information directly into the health planner 222 after communicating with the member by telephone or facsimile). FIG. 7 illustrates an exemplary interactive web-based enrollment form depicting enrollment options for a selected insurance carrier, along with fields for redeeming voucher codes.

Preferably, no money is collected from the member at the time of enrollment. Instead, the group is billed at a later date for the vouchers that have been redeemed up to that date. The health planner 222 activates the healthcare insurance plan selected by the member according to a predetermined activation schedule (306), such as upon receipt of payment of a premium from the organization for the selected healthcare insurance plan or at the time the voucher is redeemed.

After the selected insurance plan has been activated for a given member, the health planner 222 issues a membership card to the group member evidencing his or her membership in the selected healthcare insurance plan (308). The member may use the web browser 112 to access the healthcare plan provider server 102 to view and print membership cards on a home or office printer 116. The membership cards may also be used to indicate the member's participation in a discount pharmaceutical program which will be discussed in further detail later.

Finally, the healthcare plan provider bills the organization (310) for premiums relating to the healthcare plans actually selected by members of the group based upon the quantity of voucher codes received from eligible organization members. Preferably, billing is scheduled on a monthly recurring basis based upon the number of vouchers that have been redeemed by group members. For example, if a group having 100 members was provided with vouchers for all 100 members, but only 60 used the vouchers, the group would only be billed for the 60 members that actually redeemed vouchers. In this manner, an organization avoids overpayment of premiums because the bill reflects the actual usage, not a predicted usage.

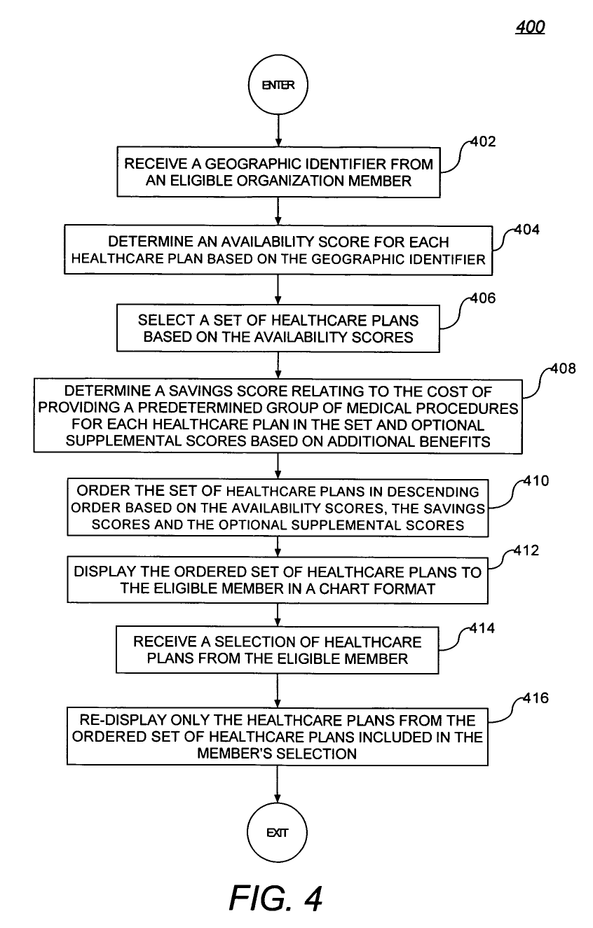

In an alternative embodiment, the healthcare planner 222 assists the eligible group member in selecting an appropriate healthcare plan by allowing each member to view and compare fees and features of healthcare plans available in a given area. By providing an extensive and well organized chart of data about available healthcare plans, the user is able to easily determine the plan that best suits his or her needs. As illustrated by the logic flow diagram 400 in FIG. 4, initially, the healthcare planner 222 requires only a geographic identifier (e.g., a ZIP code, telephone area code, street address, city, state, county, etc.) from the eligible member. The healthcare planner 222 receives the geographic indicator from the organization member (402) and determines which healthcare plans to display to the user, as well as the order of presentation, based upon the entered geographic indicator.

The healthcare planner 222 calculates an availability score for each healthcare plan stored in the healthcare provider database 224 based upon the geographic indicator entered by the member (404) and uses these availability scores to determine which plans to present to the member (406). For example, assuming for purposes of illustration that a member wishes to view available discount dental plans that are near his or her home. The member enters his or her home ZIP code (or other geographic indicator) using the web browser 112. The healthcare planner 222 displays only those dental plans having at least one dental care provider located within a given geographic distance (e.g., 50 miles) of the entered geographic identifier. Alternatively, the health care planner 222 may display only those plans whose availability score is above a predetermined threshold or only a certain number of plans with scores having the highest values.

The availability score may be determined in a number of ways. For example, assuming for illustrative purposes the method is determining the availability score for dental plans. The availability score may simply be the total number of dental care providers available within a given distance (e.g., a 50 mile radius) of a ZIP code or other geographic indicator entered by the user. Alternatively, the score may be calculated as a weighted sum of the number of dental care providers within the given distance of the ZIP code or other geographic identifier, wherein each dental care provider included in the particular healthcare plan is given a weight that is inversely proportional to the distance from his or her office location to the entered geographic identifier. In an alternative embodiment, the weight value may correspond to a given distance range (e.g., all offices located between 0 and 5 miles from a ZIP code are assigned a weight of 6, offices located between 5-10 miles from the ZIP code are assigned a weight of 5, offices located 10-20 miles away are assigned a weight of 4, etc.) Alternatively or additionally, each dental care provider may be given a weight corresponding to the provider's specialty (e.g., a general dentist, an orthodontist, a periodontist, an endodontist, a prosthodontist, an oral surgeon, a pediatric dentist, etc.).

In one embodiment, the healthcare planner 222 may generate a multitude of supplemental score values to determine the order for displaying available healthcare plans (408). For example, a savings score may be calculated as a scaled value based on the amount of money that a member would save when having the ten most popular procedures performed as compared against a sample average price for those procedures. Additionally, the healthcare planner 222 may generate any number of other optional supplemental scores (e.g., additional points for specialist availability, additional points for added benefits that come with the plan, or points for any other criteria that may be of benefit to healthcare plan provider, the organization, or the organization's members).

The healthcare planner 222 orders the plans (410) based upon a sum (e.g., weighted or otherwise) of the availability score, the savings score, and any other applicable supplemental score previously calculated. Available plans are presented to the member according to the total score for each healthcare plan (412). In one exemplary embodiment, the available plans are displayed in a comparison chart, from left to right, in descending order from highest score to lowest score such that the healthcare plan having the highest sum of scores is shown on the left side of the chart and the healthcare plan having the lowest sum of scores is shown at the right side of the chart.

In an alternative embodiment, the healthcare planner 222 initially provides the eligible member with a complete chart of all the available plans corresponding to the entered geographic indicator. In one embodiment, the user may select specific healthcare plans for comparison instead of listing all plans by using an interactive form (e.g., a form containing a check box located proximate to each healthcare plan displayed in the ordered set). This feature allows the member to gradually narrow down the choices for ultimately selecting a healthcare plan for enrollment based upon the criteria provided in the comparison chart.

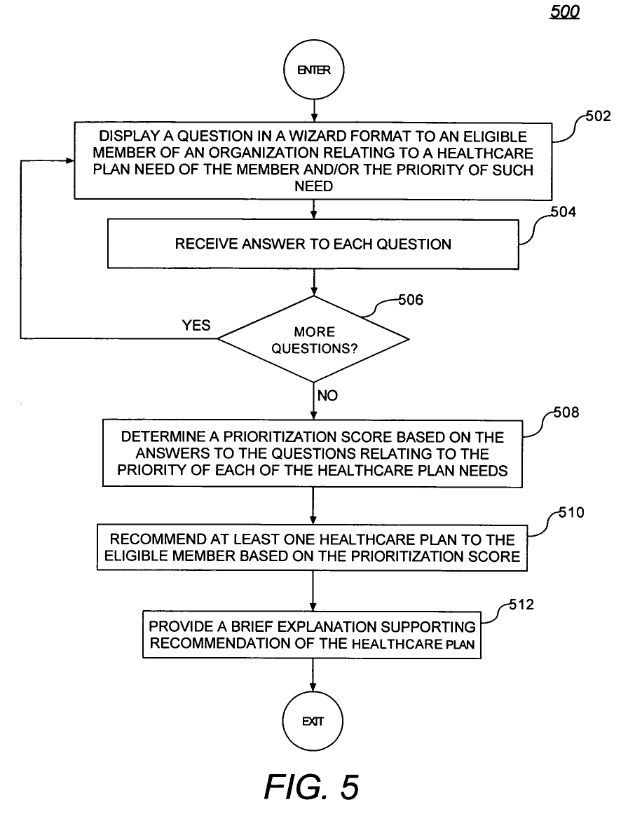

In an alternative embodiment of the present invention, as illustrated by the operational flow diagram 500 of FIG. 5, a virtual salesperson, implemented in a wizard-type format (hereinafter “the wizard”), further assists an eligible member in choosing the appropriate healthcare plans by tailoring the selection of healthcare plans to fit the needs of the individual member. The wizard allows the member to enter relevant information pertaining to his or her personal preferences and needs in an easy-to-walk-through interview process. The member answers a series of simple questions and the wizard suggests a plan or set of plans that are most ideal for that member's needs based upon an analysis of those responses.

The wizard begins by displaying a series of questions to an eligible member of an organization relating to the member's healthcare plan needs (502). The wizard presents the questions in a manner such that the member must answer one question (504) before being presented with a subsequent question. Exemplary questions may cover topics such as location of the member, specific provider needs (e.g., specialist or a specific healthcare provider that must participate), specific procedure needs (e.g., specialist only procedures or general healthcare procedures), additional feature requirements (e.g., chiropractic or prescription benefits), and plan pricing. Additionally, the wizard may also gather the degree of priority for each of these items. For example, if the member indicated that a specific healthcare provider must participate in a plan, the availability of that provider would be the first criteria used to narrow down the plan choices.

When the member has entered answers for all the questions presented (506), the healthcare planner 222 determines a prioritization score for each of the available healthcare plans based on the member's answers (508). The healthcare planner 222 compares the available data for each plan (e.g., healthcare data and sample fees) and the responses from the user. For example, if the member requested a healthcare plan providing coverage for a healthcare provider offering particular specialty services, the initial available sampling of healthcare plans may include all plans having at least one of the preferred specialty types within a given distance (e.g., 50 miles) of the member's location. Subsequent trimming of this list may be conducted according to the entries provided by the member, including the availability of a specific healthcare provider, savings and procedure relevancy, plan pricing, and any other criteria that may be relevant to choosing a healthcare provider plan. Each healthcare plan is assigned an overall prioritization score based upon the sum of scores for each relevant criteria.

After the analysis is performed, the healthcare planner provides a primary recommendation and optional secondary to the user (510) along with a brief explanation of the analysis (512). For example, the explanation may contain a brief synopsis of the evaluation such as, “The Wizard recommends Plan X because Dr. Y participates, and the fees listed for procedure Z are the lowest.”

The wizard may be implemented into a website offering multiple discount healthcare plans. Use of the wizard may assist the final end-user (e.g., members of an organization eligible to receive healthcare benefits, individual members of the public looking for a new healthcare insurance plan), organization benefits administrators, and sales representatives to find the ideal healthcare plan from the pool of available plans for an individual member.

In another embodiment, members enrolled in a healthcare plan offered through the healthcare plan provider may use the membership cards evidencing enrollment in the plan to purchase pharmaceuticals at a discounted fee. A discount program may be offered (e.g., a discount prescription program) whereby members receive prescription drugs at discounted rates at participating pharmacies when presenting his or her membership card while making the purchase. This benefit is provided by the healthcare plan provider entering into business relationships with companies (e.g., pharmacies or pharmacy benefit managers (PBMs)) that allow for use of predetermined discount cards when dispensing pharmaceuticals to consumers (602). This feature further allows marketers to generate revenue while offering a valuable and free service to clientele.

The healthcare plan provider engages marketers who promote the healthcare plan provider service by enrolling members (604) (e.g., via a website or over the phone) or distributing discount pharmacy cards. These marketers may include employees of the healthcare plan provider, third-party marketers, affiliate programs or networks, or any online affiliate operating a website that contains online tools or features for driving traffic to the healthcare plan provider's enrollment website (e.g., banner ads, pop-up windows, or hyperlinks). The healthcare planner 222 then issues the new member a discount prescription card to be used in connection with purchasing prescription medication at a participating pharmacy (606). The discount pharmacy card may be the same card issued to evidence the member's enrollment in a healthcare insurance plan. The discount pharmacy cards may be issued at no cost to the end-user or for a nominal fee. Each issued card is associated with the marketer who initially obtained the member's enrollment. The member may then use this discount prescription card at participating locations to receive pharmaceuticals at discounted prices. The discount prescription card includes a bar code, magnetic encoding, a microchip (e.g., when discount card is a smart card) or other identifying indicia to allow detection of discount card identification at a point of sale. A device at the point of sale runs a client application that supplies the discount card ID to the healthcare plan provider server 102 via the Internet for tracking and commission purposes.

The healthcare planner 222 tracks the amount of revenue acquired through each marketer by tabulating of the number of prescriptions generated by the members enrolled by each individual marketer (608). The healthcare plan provider then provides commissions to each marketer based upon the quantity of prescriptions purchased by the members using the discount prescription cards sold through the respective marketer (610).

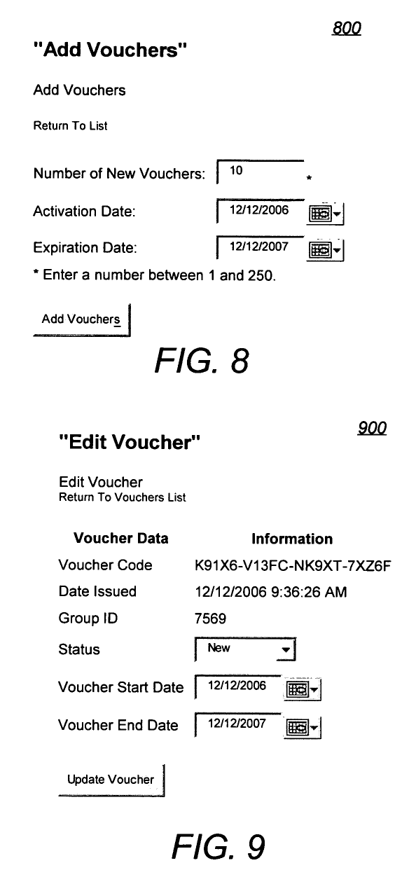

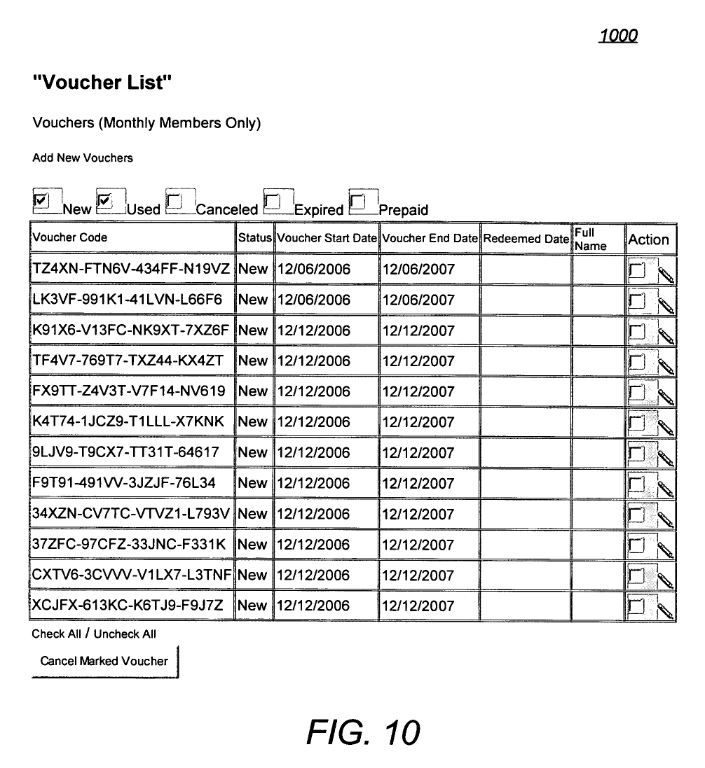

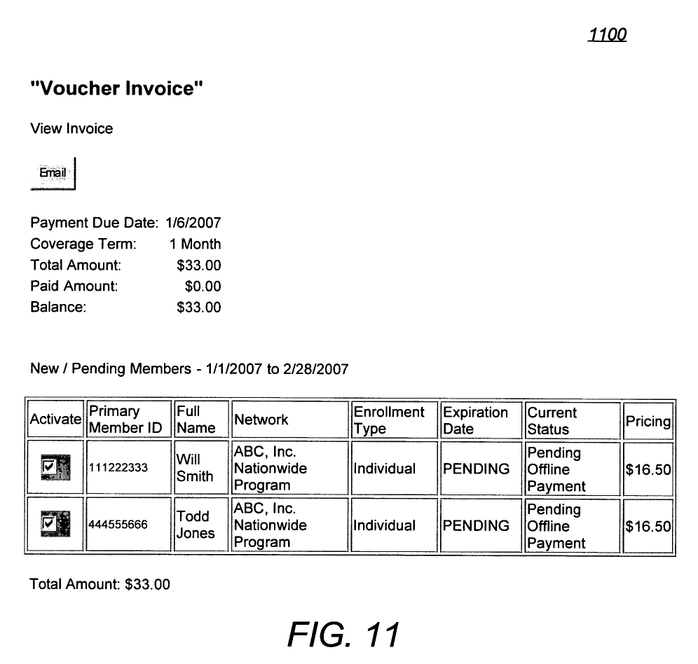

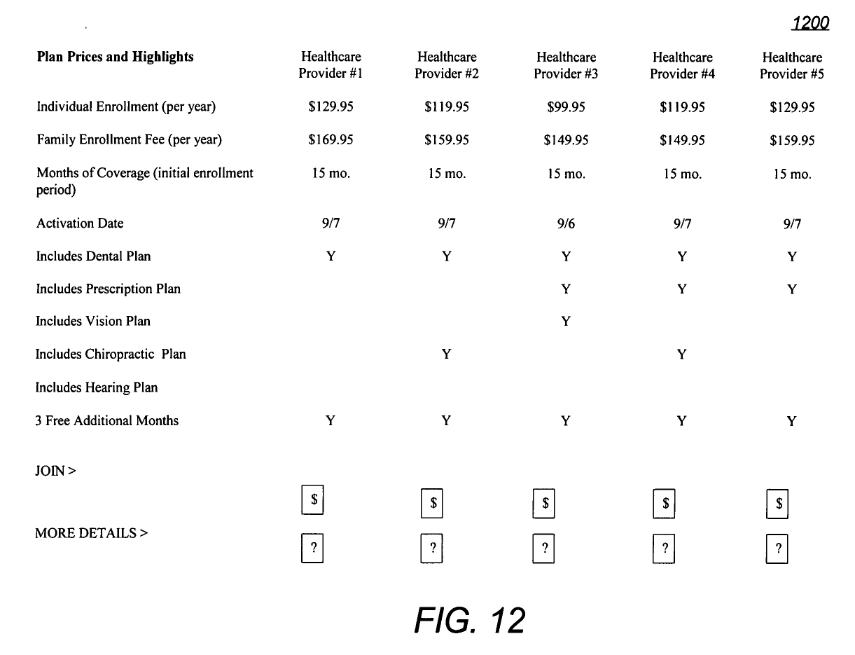

In addition to the above mentioned search and enrollment capabilities, in one embodiment, the healthcare planner 222 may also offer services to the organization's benefits administrator for management purposes. A group administrator is allowed exclusive access to a robust management panel through the web browser 112 enabling full access to monitor and control membership enrollment for the organization (e.g., request vouchers from the healthcare plan provider; monitor voucher redemption; cancel, modify, or activate memberships; review billing information; etc.). For example, FIGS. 8-11 depict exemplary views of interactive tools displayed to the group administrator for managing group enrollment and accessing billing information for the organization's healthcare benefits, in accordance with one embodiment of the present invention. The exemplary screen displayed in FIG. 8, allows the group administrator to obtain additional voucher codes from the healthcare plan provider. In FIG. 9, the status of a particular voucher may be set, as well as activation and expiration dates. FIG. 10 illustrates an exemplary tool that allows the administrator to view and/or change the status of all voucher codes issued to the organization. FIG. 11 illustrates an exemplary invoice detailing billing information for the organization.

As described above, the present invention encompasses a healthcare provider administration system and method of operation. With this invention, members of an organization who are eligible to receive healthcare benefits may select a healthcare insurance plan from a large pool of insurance plans that is most suited to fill the member's individual needs. Additionally, organizations are able to provide their members a broad selection of healthcare coverage and easily track member participation through the use of vouchers. By allowing each member to select an appropriate plan on an individual basis, employee morale, job satisfaction, and overall organization goodwill is enhanced. Additionally, the organization is able to save costs by paying insurance premiums only on an “as used” basis.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

We claim:

1. A method for arranging and displaying a plurality of healthcare plans in an electronic chart format for use by members of an organization receiving healthcare benefits from the organization, the method comprising:
receiving a geographic identifier from a member of the organization;
determining an availability score for each of the plurality of healthcare plans based on the geographic identifier to produce a plurality of availability scores;
selecting a set of the plurality of healthcare plans based on the plurality of availability scores;
determining a savings score for each of the healthcare plans in the set to produce a plurality of savings scores, each savings score relating to costs of providing a predetermined group of medical procedures;
organizing the set of healthcare plans based at least on the plurality of availability scores and the plurality of savings scores to produce an ordered set of healthcare plans; and
displaying the ordered set in a chart format.

2. The method of claim 1, wherein the step of determining an availability score comprises:
determining a quantity of healthcare providers within a predetermined distance of the geographic identifier.

3. The method of claim 2, wherein the predetermined distance is fifty miles and the geographic identifier is a zip code.

4. The method of claim 1, wherein the plurality of healthcare plans are discount dental plans, wherein the predetermined group of medical procedures is a predetermined group of dental procedures, and wherein the step of determining a savings score comprises:
determining a difference between cumulative costs associated with the predetermined group of dental procedures and cumulative reference costs associated with the predetermined group of dental procedures; and
multiplying the difference by a scaling factor.

5. The method of claim 1, further comprising:
prior to the step of organizing,
computing a sum of at least the availability score and the savings score for each of the healthcare plans in the set to produce a plurality of sums;
wherein the step of organizing includes organizing the set of healthcare plans based on the plurality of sums, such that a first healthcare plan in the ordered set is characterized by a highest sum of the plurality of sums.

6. The method of claim 5, wherein the step of displaying comprises:
displaying the ordered set in the chart in a left-to-right, highest-to-lowest score format, such that the first healthcare plan is shown at a left side of the chart and a healthcare plan characterized by a lowest sum of the plurality of sums is shown at a right side of the chart.

7. The method of claim 1, further comprising:
determining at least one other ranking score for each of the healthcare plans in the set based on at least one of specialist availability and additional benefits associated with the particular healthcare plan to produce a plurality of supplemental scores;
wherein the step of organizing includes organizing the set of healthcare plans based at least on the plurality of availability scores, the plurality of savings scores and the plurality of supplemental scores to produce the ordered set of healthcare plans.

8. The method of claim 1, further comprising:
receiving selection of at least two healthcare plans of the ordered set of healthcare plans to produce a set of selected healthcare plans; and
re-displaying only the set of selected healthcare plans in an ordered format.

9. The method of claim 8, further comprising:
providing a check box proximate each healthcare plan displayed in the ordered set;
wherein the step of receiving selection of at least two healthcare plans of the ordered set of healthcare plans includes:
detecting selection of two or more of the check boxes.

10. A processor-readable storage medium containing programming instructions for arranging and displaying a plurality of healthcare plans in an electronic chart format for use by members of an organization receiving healthcare benefits from the organization, the programming instructions, when executed by a processor, causing the processor to at least:
receive a geographic identifier input by a member of the organization;
determine an availability score for at least some of the plurality of healthcare plans based on the geographic identifier to produce a plurality of availability scores;
select a set of the plurality of healthcare plans based on the plurality of availability scores;
determine a savings score for each of the healthcare plans in the set to produce a plurality of savings scores, each savings score relating to costs of providing a predetermined group of medical procedures;
organize the set of healthcare plans based at least on the plurality of availability scores and the plurality of savings scores to produce an ordered set of healthcare plans; and
display the ordered set in a chart format.

11. A system for arranging and displaying a plurality of healthcare plans in an electronic chart format for use by members of an organization receiving healthcare benefits from the organization, the system comprising:
a web server including a processor and a processor-readable storage medium, the processor-readable storage medium containing programming instructions that, when executed by the processor, cause the processor to at least:
receive a geographic identifier input by a member of the organization;
determine an availability score for at least some of the plurality of healthcare plans based on the geographic identifier to produce a plurality of availability scores;
select a set of the plurality of healthcare plans based on the plurality of availability scores;
determine a savings score for each of the healthcare plans in the set to produce a plurality of savings scores, each savings score relating to costs of providing a predetermined group of medical procedures;
organize the set of healthcare plans based at least on the plurality of availability scores and the plurality of savings scores to produce an ordered set of healthcare plans; and
display the ordered set in a chart format; and
a communication connection coupling the web server to the Internet.
